(19) United States
(12) Patent Application Publication
(10) Pub. No.: US 2015/0020353 A1
(43) Pub. Date: Jan. 22, 2015

(54) GRILLE SECURING DEVICE

(71) Applicant: Peter J. Tast, Northport, NY (US)

(72) Inventor: Peter J. Tast, Northport, NY (US)

(21) Appl. No.: 14/332,606

(22) Filed: Jul. 16, 2014

Related U.S. Application Data
(60) Provisional application No. 61/846,743, filed on Jul. 16, 2013.

(51) Int. Cl. F16B 5/06; F16B 5/02

(52) U.S. Cl. CPC F16B 5/0685; F16B 5/02
USPC 24/455; 52/741.1

(57) ABSTRACT

The present disclosure is directed to devices for securing grilles or decorative architectural elements. The present disclosure is also directed to devices that secure a grille to a frame such as a suspended or dropped ceiling grid system.

### FIELD OF THE DISCLOSURE

The disclosure relates generally to the field of devices for securing grilles or decorative architectural elements. More specifically, the present disclosure is directed to devices that secure a grille to a frame-such as a suspended or dropped ceiling grid system.

### BACKGROUND OF THE DISCLOSURE

Typical fluorescent light panels or heating, ventilation and air conditioning (HVAC) intakes or outlets are installed in dropped ceilings and walls in a work environment. These panels, intakes or outlets typically include a cover, such as a metal structure, a diffuser or a lens. Typically a user is unable to modify the appearance of a light panel or an HVAC intake or outlet without removing their covers or modifying their structures.

What is desired are devices that can modify the appearance of light panels, HVAC intakes and outlets or any other element that is suspended in a ceiling without removal or structural modification of the already present element.

Embodiments of the present application provide devices that address the above and other issues.

### SUMMARY OF THE DISCLOSURE

The present disclosure is directed to devices for securing grilles. The present disclosure is also directed to devices that secure a grille or decorative architectural element to a frame such as a suspended or dropped ceiling grid system.

### BRIEF DESCRIPTION OF THE DRAWINGS

These and other features, aspects, and advantages of the present invention will become better understood with regard to the following description, claims, and accompanying drawings wherein:

FIG. 1 illustrates an isometric view of one embodiment of the present disclosure;

FIG. 2 illustrates a right side view of one embodiment of the present disclosure;

FIG. 3 illustrates a top view of one embodiment of the present disclosure;

FIG. 4 illustrates four clips attached to a rear face of a grille;

FIG. 5 illustrates a zoomed in view of one clip attached to a rear face of a grille; and

FIG. 6 illustrates a zoomed in view of one clip as it rotates about an axis.

### DETAILED DESCRIPTION OF THE DISCLOSURE

This disclosure includes devices that can secure a grille or decorative architectural element over light panels, HVAC intakes and outlets or any other element that is suspended in a ceiling, such as a dropped ceiling.

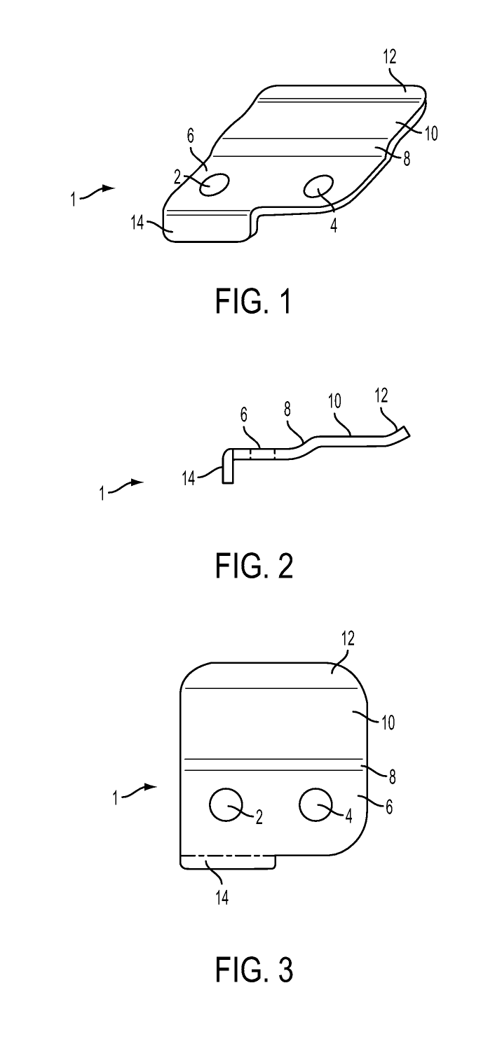

FIG. 1 illustrates an isometric view of clip 1. Clip 1 can be constructed of any suitable material including but not limited to metals such as aluminum and plastics such as thermoplastics.

Clip 1 includes two holes 2 and 4. In this embodiment, holes 2 and 4 are of sufficient size to allow for the shaft of a screw to pass through them but in other embodiments, holes 2 and 4 could be much smaller or much larger and of sufficient size to allow any suitable fastener to pass through them. In this embodiment of Clip 1, two holes 2 and 4 are shown, but in other embodiments one, three or more holes can be included. The two holes 2 and 4 are included in a substantially flat first portion 6 of clip 1. Holes 2 and 4 can be located at other positions on first portion 6, which differ from the positions illustrated in FIG. 1.

From the perspective of FIG. 1, on the distal end of first portion 6 a first angled portion 8 connects portion 6 with a substantially flat second portion 10. The vertical rise caused by first angled portion 8 is further understood in reference to FIG. 2 discussed below. From the perspective of FIG. 1, on the distal end of second portion 10 is a second angled portion 12. The vertical rise caused by second angled portion 12 is further understood in reference to FIG. 2 discussed below. Second portion 10 and first portion 6 are substantially parallel or parallel to each other.

On the proximal end of first portion 6 is a tab 14 that is angled to be approximately perpendicular to first portion 6. Tab 14 extends a distance vertically below the surface of first portion 6, the distance being approximately half of the distance between tab 14 and first angled portion 8 on first portion 6.

Referring now to FIG. 2, a side view of clip 1 can be seen. As can be seen in FIG. 2, second portion 10 is a vertical distance above first portion 6. The distance second portion 10 is vertically above first portion 6 is approximately a third of the length of tab 14. Further, second angled portion 12 is at approximately a 30° angle from second portion 10, but this angle could be made larger or smaller in other embodiments based on desired application.

Referring now to FIG. 3, the corners of clip 1 are shown as being rounded, but, in other embodiments the corners can meet at right angles or have smaller or larger radii of curvature.

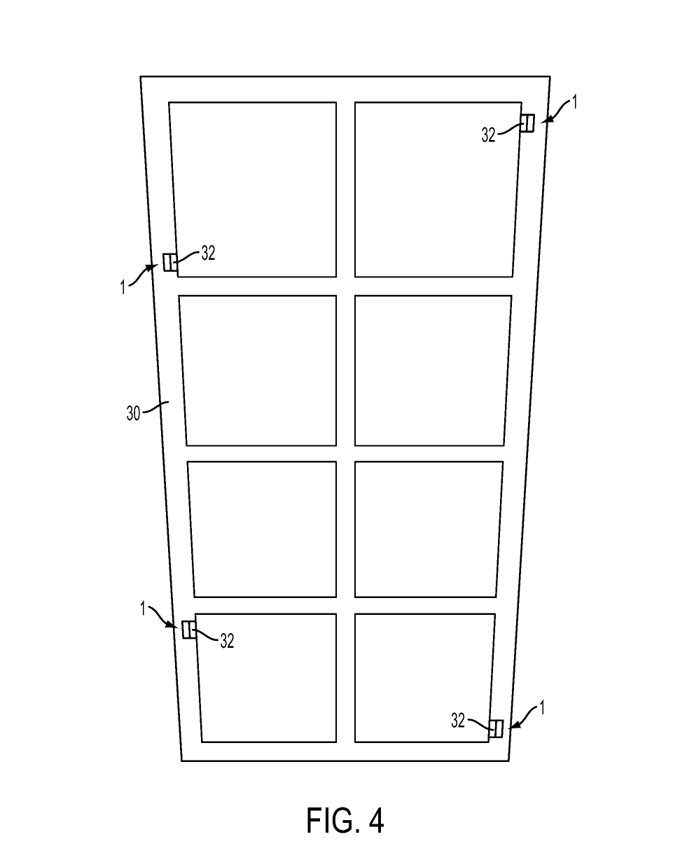

Referring now to FIG. 4, one embodiment of a grille 30 can be seen. In this embodiment, grille 30 is designed to cover a fluorescent lighting panel and separate the panel into eight substantially square portions. In other embodiments, grille 30 can include a different number of portions and in different shapes. In other embodiments, grille 30 can be designed to cover an HVAC inlet or outlet, or could be designed to cover or replace a portion of a dropped ceiling.

The view as shown in FIG. 4 is of the rear face of grille 30 that, when installed, is towards the light panel. From this view, four clips 1 can be seen that are arranged along the longer sides of grille 30. In other embodiments, clips can be arranged in different configurations along the grille 30 and in other embodiments, 1, 2, 3, 5, 6, 7, 8 or more clips can be arranged along the grille 30.

As seen in FIG. 4, the clips are arranged so that the second angled portion (12 as shown in FIG. 2) is extended towards the exterior boundary of the grille 30 and the tab (14 as shown in FIG. 2) extends towards the front face of the grille 30. To secure each of clips 1 to the grille 30, one screw is driven through one of the holes (2 or 4, as shown in FIG. 1) and into the grille 30 material. The grille 30 can be composed of any suitable material, including but not limited to woods, metals such as aluminum and plastics such as thermoplastics. In other embodiments another fastening device, such as a nail or bolt, can be driven through a hole in clip 1. In other embodiments, both holes (2 or 4, as shown in FIG. 1) can have fastening devices passing through them.

Although different size clips can be used for different applications the size of the clip as shown in FIG. 4 is about one inch by about one inch when measured in the configuration illustrated in FIG. 3. FIG. 4 illustrates clip 1 attached to a grille designed to cover a fluorescent light box of about 2′ by 4′. Although clip 1 in FIG. 4 is about one inch by about one inch, other clips could be much smaller or much larger, such as being as small as about 0.25″ by about 0.25″ and being about as large as about 6″ by about 6″, in other embodiments.

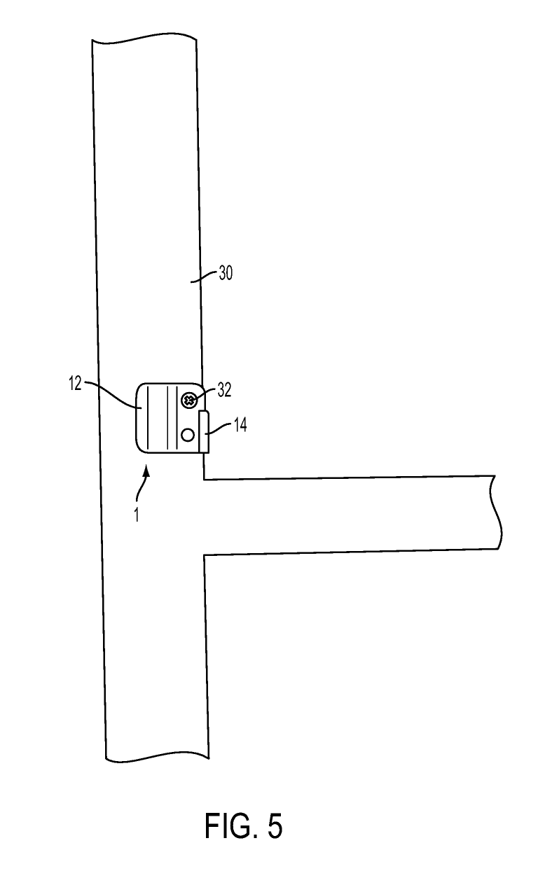

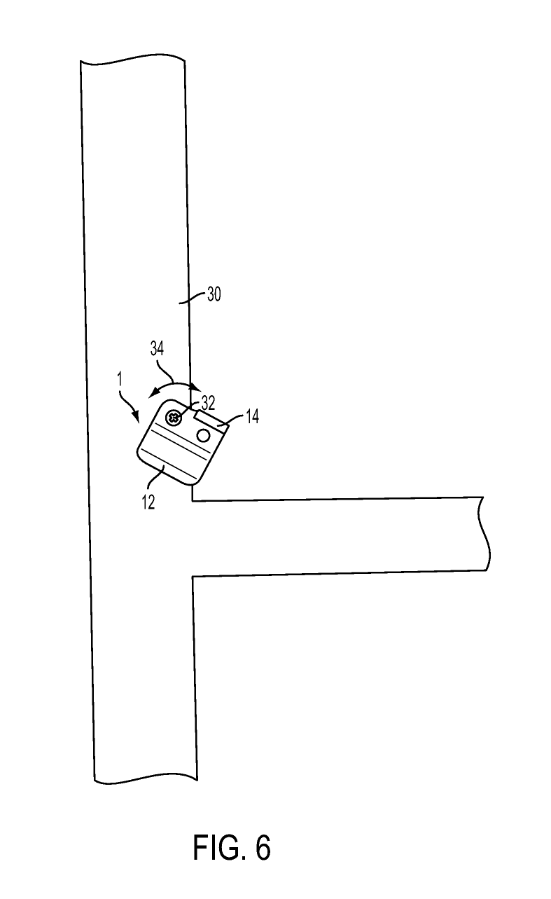

FIG. 5 illustrates a zoomed in view of one of the clips on the grille 30 of FIG. 4. As can be seen from the embodiment illustrated in FIG. 5, second angled portion 12 extends towards the exterior boundary of the grille 30 and the tab 14 extends towards the front face of the grille 30. In the embodiment illustrated in FIG. 5, the use of screw 32 allows clip 1 to rotate about the axis of screw 32, which is illustrated in FIG. 6.

As shown in FIG. 6, clip 1 can rotate about the axis of screw 32, as indicated in directional arrows 34. Clip 1 can rotate several degrees about the axis formed by screw 32 and is only limited by tab 14 abutting the edges of the grille 30.

The following example serves to illustrate aspects of the disclosure but is not intended to limit the scope of the disclosure.

### EXAMPLES

The following example illustrates the use of a number of clips.

In this example, a user desires to cover a fluorescent light panel installed in a dropped ceiling with a decorative wood frame. The user secures four clips 1 to a wooden grille that is the same size as the light panel, in the same configuration they are shown in FIG. 4.

In this example the two clips 1 towards the left side of FIG. 4 include two screws, one in each of holes 2 and 4. In this example, the two clips 1 towards the right side of FIG. 4 include only one screw, which is secured through hole 4 into wooden grille 30. Since a single screw 32 is driven through clip 1, the clip 1 can rotate as shown in FIG. 6.

To install the grille 30, the user first slides the two clips on the left hand side of FIG. 4 between the light panel/fixture and the frame/grid of the dropped/suspended ceiling. In this configuration, the second portion 10 is between the visible dropped ceiling frame/grid and the frame of the light panel.

After the left hand side of grille 30 is placed, the user lifts the right hand side of grille 30 so that grille 30 is substantially parallel with the light panel. Once grille 30 is substantially parallel to the light panel, the two clips 1 on the right are rotated clockwise by pressing tab 14, causing second angled portion 12 to slide between the visible dropped ceiling frame and the frame of the light panel. The second portion 10 of these clips is also then between the visible dropped ceiling frame and the frame of the light panel.

The four clips 1 then support grille 30 and maintain grille 30′s position over the light panel/fixture.

The described embodiments and examples of the present disclosure are intended to be illustrative rather than restrictive, and are not intended to represent every embodiment or example of the present disclosure. Various modifications and variations can be made without departing from the spirit or scope of the disclosure as set forth in the following claims both literally and in equivalents recognized in law.

What is claimed is:

1. A clip device comprising:
a substantially flat first portion, wherein the substantially flat first portion has at least one hole formed therein;
a first angled portion, wherein the first angled portion is formed on a distal edge of the substantially flat first portion;
a substantially flat second portion, wherein the substantially flat second portion is formed on a distal edge of the first angled portion; and
a second angled portion, wherein the second angled portion is formed on a distal edge of the substantially flat second portion.

2. The device of claim 1, further comprising a tab, wherein the tab is formed on a proximal edge of the substantially flat first portion and extends a distance vertically below a lower surface of the substantially flat first portion.

3. The device of claim 2, wherein the tab extends a distance below the lower surface of the substantially flat first portion, the distance being about half of a distance between the tab and the first angled portion.

4. The device of claim 2, wherein the tab extends along a portion of the proximal edge of the substantially flat first portion, the portion being about half of the length of the edge of the substantially flat first portion.

5. The device of claim 1, wherein the second angled portion is at about a 30° angle from an upper surface of the substantially flat second portion.

6. The device of claim 1, wherein the device is formed of metal, plastic, or combinations thereof.

7. A method for securing a grille or decorative architectural element to a frame, the method comprising:
securing one or more clip devices to a grille or decorative architectural element;
placing a surface of the grille or decorative architectural element on a front surface of the frame; and
rotating the one or more clip devices about an axis so that the clip device contacts the grille or decorative architectural element, wherein at least a second angled portion of each of the one or more clip devices is contacting a rear surface of the frame.

8. The method of claim 6, wherein each of the one or more clips comprises:
a substantially flat first portion, wherein the substantially flat first portion has at least one hole formed therein;
a tab, wherein the tab is formed on a proximal edge of the substantially flat first portion and extends a distance vertically below a lower surface of the substantially flat first portion;
a first angled portion, wherein the first angled portion is formed on a distal edge of the substantially flat first portion;
a substantially flat second portion, wherein the substantially flat second portion is formed on a distal edge of the first angled portion; and
a second angled portion, wherein the second angled portion is formed on a distal edge of the substantially flat second portion.

9. The method of claim 6, wherein two or more clip devices secure the grille to the frame or decorative architectural element.

10. The method of claim 8, wherein one of the two or more clip devices is secured with one fastener and another of the two or more clip devices is secured with two or more fasteners.

11. The method of claim 8, wherein the frame is a suspended ceiling grid.

12. The method of claim 8, wherein the tab contacts the grille or decorative architectural element upon rotation of the one or more clip devices about the axis.
